(19) United States
(12) Patent Application Publication
(10) Pub. No.: US 2006/0156938 A1
(43) Pub. Date: Jul. 20, 2006

(54) Cleaning device for printing cylinders

(76) Inventor: Richard Munz, FREIBURG I. BR. (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/568,032

(22) PCT Filed: Sep. 22, 2004
(86) PCT No.: PCT/EP04/10601

§ 371 Date: Feb. 10, 2006

(30) Foreign Application Priority Data
Sep. 24, 2003 (DE) 103 44 115.8

(51) Int. Cl. B41F 35/02; B41F 35/00

(52) U.S. Cl. 101/425

(57) ABSTRACT

A cleaning device (1, 1′) for printing cylinders of rotary presses is provided. The cleaning device includes a guide rail (2), mounted generally parallel to the printing cylinder, and a washing device (4) is guided on the rail o as to be longitudinally displaceable. The washing device (4) has at least one rotationally driven cleaning brush (8) with at least one axis of rotation arranged approximately parallel to that of the printing cylinder. The washing device (4) is held on a longitudinal side of the guide rail (2) facing the printing cylinder so that the washing device can move, and the axis of rotation of the at least one cleaning brush (3) is arranged between planes formed by a top side and a bottom side of the guide rail (2). The cleaning device (1) has a space-saving and compact design anc can be mounted in a rotary press even where there is little space, for example in the vicinity of adjacent printing cylinders.

### BACKGROUND

The invention relates to a cleaning device for printing cylinders and printing-plate cylinders of rotary presses. The cleaning device comprises a guide rail arranged parallel to the printing cylinder, with a washing device being guided on the rail so as to be longitudinally displaceable. The washing device comprises at least one cleaning brush that is rotationally driven about an axis of rotation arranged approximately parallel to the printing cylinder.

During the printing process, ink and paper dust deposits collect on the cylinders of rotary presses. These deposits accumulate with increasing runs and after a certain quantity collects, negatively affect the printing quality. In order to be able to clean the printing cylinders in a rotary press from time to time when necessary, automated washing systems have been created, which comprise a rotary cleaning brush or a cleaning cloth, which is unwound in sequence, and which is wetted with washing agent and water by means of a nozzle-spraying system, and which is brought into its cleaning position by adjusting the rotating printing cylinder.

Such washing systems are allocated rigidly to the printing cylinder and are used to wash the printing cylinders according to a certain cycle after a number of printings during production and after the end of production. This process washes away the ink and paper dust deposits. The freshly cleaned rubber blanket of the rubber blanket printing cylinder guarantees proper printing in terms of quality for continuous printing runs or proper starting conditions after an order change.

From EP 1 163 115 B1, a cleaning device of the type noted above and designed for the printing cylinder of a rotary press is already known, which has a guide rail arranged parallel to the printing cylinder. A sled is guided on this guide rail so that it can move longitudinally. The sled can be connected detachably to a washing device, wherein the guide rail is adjustable towards the printing cylinder for placing the washing device on the printing cylinder and wherein the washing device is connected to a supply unit via supply lines for washing agent, air, and power supply. Because, for safety-related reasons, it is frequently not permissible to feed the supply media, namely electrical power, hot water, and washing agent, into the printing presses in the direct vicinity of rotating printing cylinders, the supply lines for the cleaning device previously known from EP 1 163 115 B1 are guided from the stationary connection point to the sled via supply lines within the guide rail. Because the washing device in the previously known cleaning device is held detachably on the sled, the cleaning device shown in EP 1 163 115 B1 is built relatively tall. However, such a tall structure could possibly be a disadvantage under the narrow spatial relationships in rotary presses.

From EP 0 928 687 A1, a cleaning device for rotary machines is described, having a guide rail oriented parallel to the press cylinder. On this guide rail, a washing device is longitudinally movable. The washing device includes a cleaning brush that is rotatably mounted on an axis parallel to the press cylinder. The cleaning brush is arranged with a rotatable drive, located in the housing of the cleaning device on an axis parallel to the cleaning brush and located behind it. In that the cleaning brush and the associated drive arrangement have a not insubstantial construction space requirement, this known cleaning device has, in comparison to the guide rail, large outer dimensions. As discussed above, a construction of this type can be disadvantageous in view of the narrow spatial relations in rotary presses.

### SUMMARY

Therefore, the objective is to create a cleaning device of the type noted above, which has a relatively compact and space-saving design.

According to the invention, this is met, for the cleaning device of the type named above, through the characteristics of the invention. In the cleaning device according to the invention, the rotary drive allocated to the one or more cleaning brushes is arranged in the circular envelope formed by the outer periphery of the brushes. The rotational drive necessary for rotating the cleaning brushes therefore requires no additional height in the configuration of the cleaning device according to the invention. In the cleaning device according to the invention, the washing device is held so that it can move not on the top side of the guide rail, but instead on the longitudinal side facing the printing cylinder, and the rotation axis of the at least one cleaning brush is arranged between the planes formed by the top and bottom sides of the guide rail, so the space saving arrangement of inventive cleaning device is additionally improved. The cleaning device according to the invention thus also has a small height in the region of the washing device, so that this cleaning device can also be used advantageously in the interior of a rotary press under narrow spatial relationships.

It is especially advantageous when the rotational drive is formed as an electric drive integrated into the one or more cleaning brushes.

Here, in one especially advantageous improvement according to the invention, the rotational drive is arranged at least in regions within a brush body with cleaning bristles for the cleaning brush. In this embodiment, the rotational drive is thus housed in the interior of the brush body with cleaning bristles.

In this way, it is especially advantageous when the rotor of the rotational drive is formed as a brush body.

Instead, however, it is also possible that the brush body is guided on a rotationally driven shaft locked in rotation but displaceable or movable in the longitudinal direction.

### BRIEF DESCRIPTION OF THE DRAWINGS

Additional features of the invention result from the following description of embodiments according to the invention in connection with the claims as well as the drawing. The individual features can each be implemented individually or in combination for an embodiment according to the invention.

Shown are:

FIG. 1 a perspective view of a cleaning device for printing cylinders of rotary presses,

FIG. 2 a side view of the cleaning device from FIG. 1,

FIG. 3 a cross-sectional view of the cleaning device from FIGS. 1 and 2, and

FIG. 4 a view of a cleaning device, which is comparable with FIGS. 1 to 3 and which has a washing device with a cleaning brush comprising a brush body guided locked in rotation on a rotationally driven shaft but displaceable in the longitudinal direction.

### DETAILED DESCRIPTION OF THE PREFERRED EMBODIMENTS

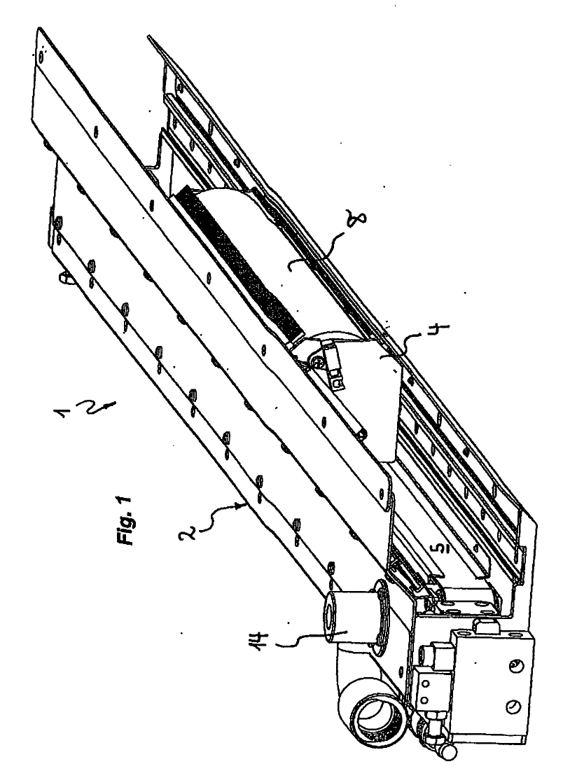

In FIGS. 1 to 3, a cleaning device 1 is shown, which is designed for cleaning the printing cylinders and especially the plate cylinders or rubber-coated cylinders in rotary presses.

The cleaning device 1 has a guide rail 2, which is arranged approximately parallel to the printing cylinders. A preferably detachable washing device 4, which here has at least one cleaning brush 8, is guided on the guide rail, and is displaceable in the longitudinal direction.

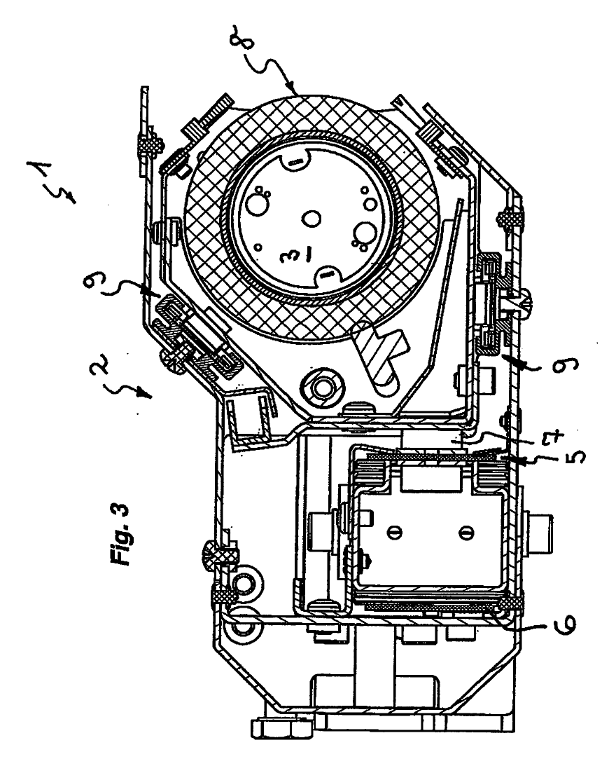

As becomes clear from FIG. 3, the guide rail 2 has on the inner side a suction channel, which is arranged between the two sections 5, 6 of a belt circulating over deflection devices. Here, a belt section 5 of the belt designed for transporting the washing device 4 forms an essentially tight cover of the suction channel open on one longitudinal side and formed by the rail interior of the guide rail 2.

From FIG. 3 it can also be seen that in the region of the washing device 4, there is a connection channel, which leads outwards into the interior of the suction channel and which is here formed by at least one connection sleeve 7. This connection sleeve 7 passes through an opening in the adjacent belt section 5, such that this forms the driving connection between the belt and the washing device 4.

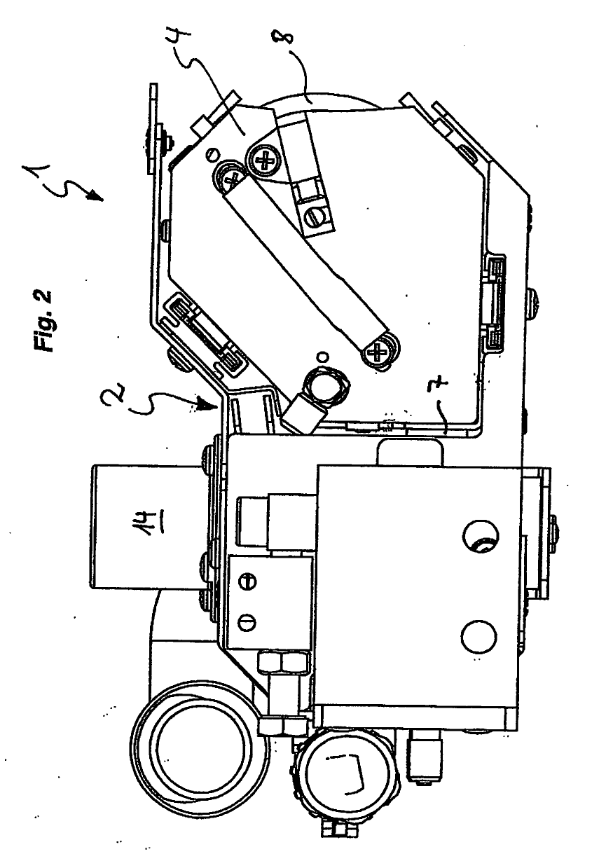

From FIGS. 2 and 3 it becomes clear that the washing device 4 is held so that it can move on the longitudinal side of the guide rail 2 facing the printing cylinder. Here, the axis of rotation of the one or more cleaning brushes 8 is arranged between the planes formed by the top and bottom sides of the guide rail 2. Through this configuration of the cleaning device 1, this can be mounted in a rotary press even under narrowed spatial conditions, such that its cleaning brush 8 applies pressure on the printing cylinder to be cleaned. In this way, the cleaning device 1 can have a space-saving design, such that such cleaning devices can also be housed in the region of adjacent printing cylinders of one rotary press.

The space-saving design of the cleaning device 1 is supported if the rotational drive 3 allocated to one or more cleaning brushes 8 is arranged in the circular envelope formed by the outer periphery of the brushes. From a comparison of FIGS. 1 to 3, it can be seen that the rotational drive 3 formed as an electronic drive is arranged at least in regions and here completely within an envelope of the brush body with cleaning bristles for the cleaning brushes 8. In this way, the rotor of the rotational drive 3 is formed as a brush body.

From FIG. 1, it follows that the housing of the washing device 4 can move in the guide rail 2 along longitudinally oriented sliding rails 9. The washing device 4 extends in the longitudinal direction, namely only over a partial area of the printing cylinder to be cleaned, so that sides and parts of sides arranged also individually on the printing cylinders can be cleaned with the help of the washing device 4. In FIGS. 1 and 2, the rotational drive 14 of the belt designed for moving the washing device 4 can also be seen.

As is visible especially from FIG. 3, the washing device 4 and especially its guide rail 2 are formed from angled sheets, which are screwed, riveted, or similarly connected to each other. In contrast, a preferred embodiment not shown here provides that the guide rail 2 and/or the washing device is produced from an extruded section and especially from an aluminum extruded section. A guide rail produced from an extruded section offers a high degree of inherent stability and significantly reduces the expense associated with the production and assembly.

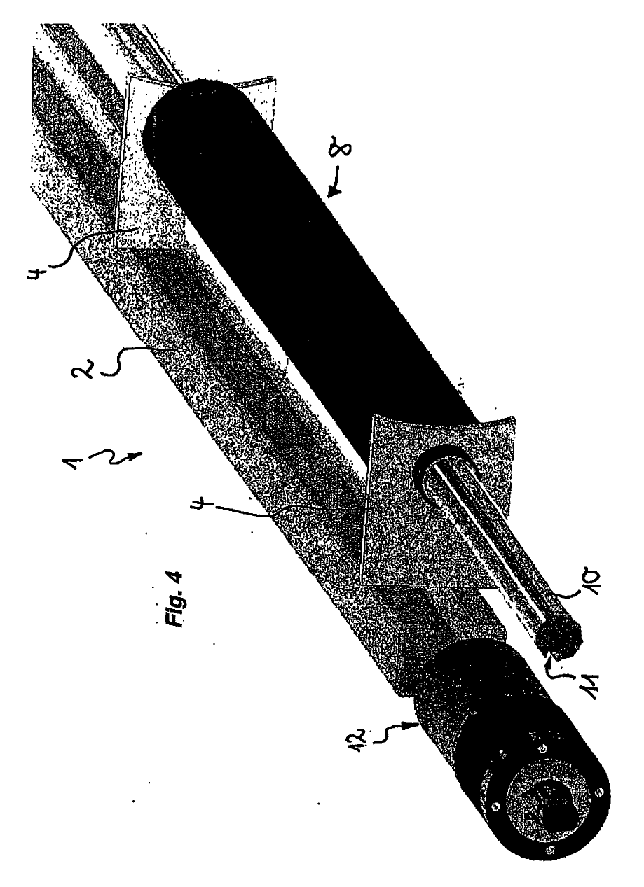

In FIG. 4, a cleaning device 1′ is shown in a schematic view, which is comparable with the cleaning device in FIGS. 1 to 3. The cleaning device 1′ also has a washing device 4, which is also indicated by its side parts and which is held on a movable sled that is not shown here, including a cleaning brush 8. This cleaning brush can move via the sled in the longitudinal direction along the guide rail 2. In order to be able to move the cleaning brush 8 along the guide rail 2, its brush body is guided locked in rotation on a rotationally driven shaft 10 but displaceable in the longitudinal direction. For this purpose, the shaft 10 has a longitudinal groove 11, in which a sliding pad engages. The pad projects onto the inner periphery of the brush body but is not shown further here. In this way, the shaft 10 can be in drive connection via a belt or chain drive with a driving motor 12, which is arranged in the extension of the guide rail 2. The embodiment shown in FIG. 4, for which the sled is also held moveable on the longitudinal side of the guide rail 2 facing the printing cylinder, supports a design, for which the axis of rotation formed by the shaft 10 for the one or more cleaning brushes is arranged between the planes formed by the top and bottom sides of the guide rail 2.

1. A cleaning device (1, 1′) for printing cylinders and printing plate cylinders of rotary presses comprising a guide rail (2), which is arranged generally parallel to the printing cylinder and on which a washing device (4), located on a longitudinal side of the guide rail (2) facing the printing cylinder, is movably guided, and includes at least one rotationally driven cleaning brush (8) located on an axis parallel to the printing cylinder and arranged between planes formed by a top side and a bottom side of the guide rail (2), wherein the rotational drive (3) allocated to the at least one cleaning brush (8) is arranged in a circular envelope formed by an outer periphery of the cleaning brush.

2. (canceled)

3. Cleaning device according to claim 1, wherein the rotational drive (3) is formed as an electric drive integrated into the at least one cleaning brush (8).

4. Cleaning device according to claim 1, wherein the rotational drive (3) is arranged at least in regions within a brush body with cleaning bristles for the at least one cleaning brush (8).

5. Cleaning device according to claim 1, wherein a rotor of the rotational drive (3) is formed as a brush body.

6. Cleaning device according to claim 1, wherein the brush body is guided locked in rotation on a rotationally driven shaft (10) and displaceable or movable in a longitudinal direction.

7. Cleaning device according to claim 1, wherein the guide rail and/or the washing device are produced from an extruded section and especially from an aluminum extruded section.
